(19) United States
(12) Patent Application Publication
(10) Pub. No.: US 2005/0145346 A1
(43) Pub. Date: Jul. 7, 2005

(54) Shutter slat fastening device

(76) Inventor: Chin-Fu Chen, Changhua Hsien (TW)

Correspondence Address: BIRCH STEWART KOLASCH & BIRCH, PO BOX 747, FALLS CHURCH, VA, 22040-0747, US

(21) Appl. No.: 10/751,413

(22) Filed: Jan. 6, 2004

(51) Int. Cl. E06B 9/38

(52) U.S. Cl. 160/178.1 R

(57) ABSTRACT

A shutter slat fastening device for fastening a shutter slat is substantially a hollow barrel which has an axial transverse beam. The transverse beam has a hole in the center to couple with a shutter rod on a window. The fastening device has a vertical plate on the upper side to form two housing troughs with the outer side of the fastening device. The housing troughs have one closed end and another open end. A bracing rod is extended from the closed end to couple with the shutter slat. The fastening device has two slots on the upper side. Each slot has one side forming an undulate slip-resistant section to fasten the shutter slat rapidly and securely without dropping.

### FIELD OF THE INVENTION

The present invention relates to shutter slats and more particularly to a fastening device for fastening shutter slats rapidly and securely.

### BACKGROUND OF THE INVENTION

Conventional shutter slat fastening devices, as shown in FIG. 1, generally comprises a hollow barrel 1 made from plastic. The barrel 1 has a horizontal coupling section 2 on the top. The coupling section 2 has a pair of threading elements 3 at the front and the rear side in a parallel manner. The threading elements 3 are plates spaced from the surface of the coupling section 2 at a defined distance. The threading elements 3 are formed by bending and extending the surface of the coupling section 2 with a notch 4 in the middle section. The notch 4 divides the threading elements 3 into two sections of different lengths on the left side and the right side. The notches 4 of the two pairs of threading elements 3 are staggered. Two pendant shutter slats a are threaded respectively on the threading elements 3. The shutter slat a has a top section stitched to form a coupling ear a1 which may be coupled on the threading elements 3 through the notch 4. To couple the shutter slats a, the coupling ear a1 must first be folded, and the longer threading element 3 should be lifted upwards to enlarge the notch 4 so that one side of the shutter slat a may be moved to couple on the longer threading element 3; then the shorter threading element 3 is lifted to couple other side of the shutter slat a. In the coupling process, the threading elements 3 have to be bent frequently, thus fracturing the threading elements 3. When the curtain slat a is thicker, coupling becomes difficult. Moreover, the threading elements 3 are made from plastic which has limited elasticity. After having been lifted and bent a few times, they become elastically deformed and cannot return to the horizontal clamp position retain the curtain slat a.

### SUMMARY OF THE INVENTION

Therefore the present invention aims to provide a shutter slat fastening device to fasten pendant and pliable shutter slats. The shutter slats may be slid with the fastening device on an angular rod located above the window to rapidly and securely couple the shutter slats.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional shutter slat fastening device.

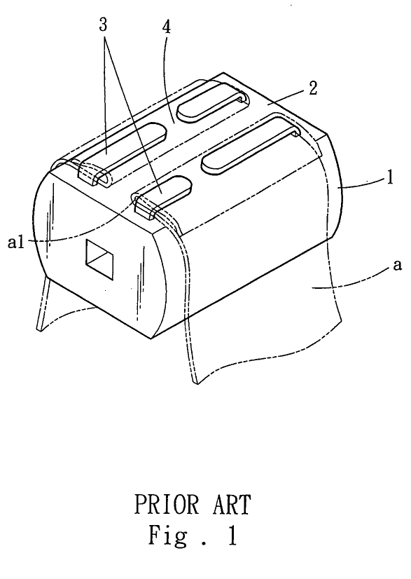

FIG. 2 is an exploded view of an embodiment of the present invention.

FIG. 3 is another perspective view of the fastening device of the present invention.

FIG. 4 is a side view of the fastening device of the invention coupling with shutter slats.

FIG. 5 is a top view of the fastening device of the invention.

### DETAILED DESCRIPTION OF THE PREFERRED EMBODIMENTS

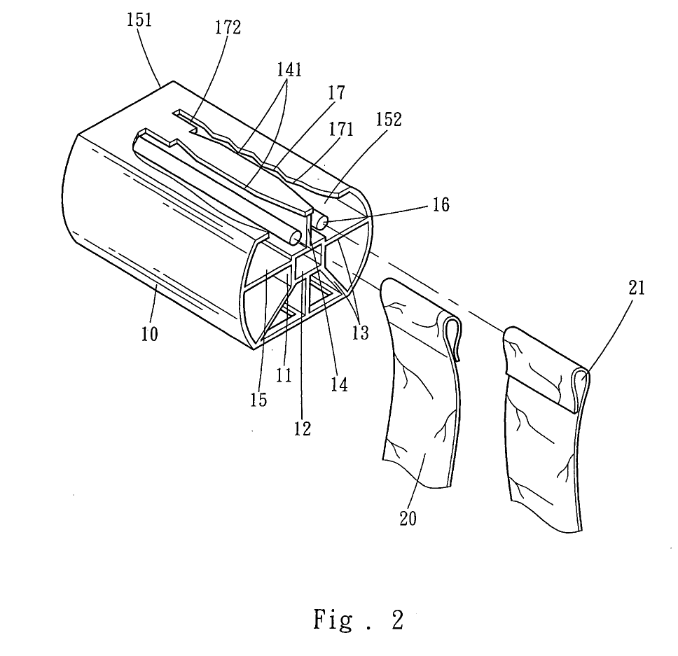

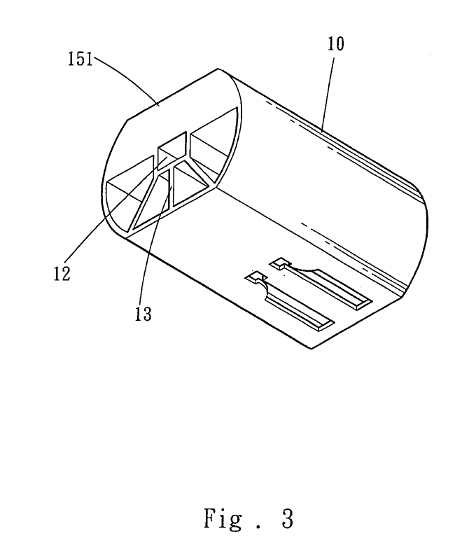

Please refer to FIG. 2, the shutter slat fastening device 10 according to the invention is substantially a hollow barrel made from plastic. A pendant and pliable shutter slat 20 hangs from a front side and a rear side respectively. The shutter slat 20 has a thread hole 21 formed on an upper end by stitching. The fastening device 10 has a transverse beam 11 in the axial direction. The transverse beam 11 has a polygonal hole 12 in the center to house a square rod (not shown in the drawing) mounted above a window to enable the fastening device 10 to be moved reciprocally without turning. The transverse beam 11 has a plurality of radial ribs 13 connecting to the inner wall of the fastening device 10. Among the radial ribs 13, there is a pair of ribs 13 extending horizontally to the left side and the right side to form a spacer. The transverse beam 11 also has a vertical plate 14 extending upwards. The vertical plate 1 has a top side extending horizontally forwards and rearwards to form clamping edges 141. The vertical plate 14 and the outer side of the fastening barrel 10 form a housing trough 15 in-between. The housing trough 15 has one closed end 151 (as shown in FIG. 3) and another open end 152. There are two bracing rods 16 extending from the closed end of the housing troughs to couple with the threading hole 21 of the shutter slat 20.

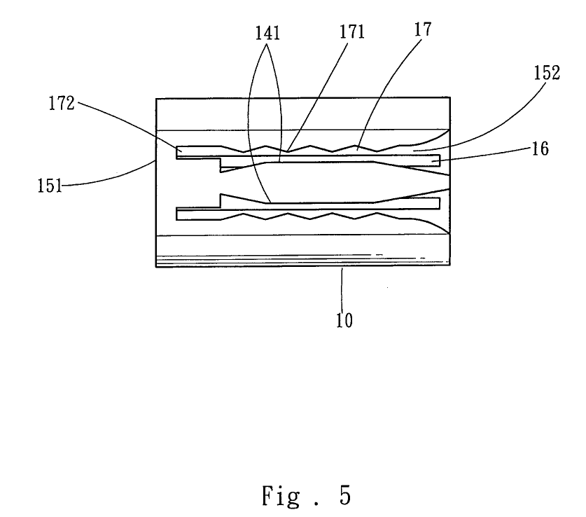

The top side and the bottom side of the fastening barrel 10 are horizontal. The top side has respectively a slot 17 formed on a front side and a rear side in parallel with each other to allow the shutter slat 20 to pass through and also to clamp the shutter slat 20. The slot 17 has an undulate outer edge to form a slip-resistant section 171. The clamping edge 141 abutting the closed end 151 of the housing trough 15 has a step-like extension away from the centre (as shown in FIG. 5) to form a narrower clamping section 172 to clamp the shutter slat 20. The slot 17 gradually extends to form a horn shape at the open end to facilitate coupling the shutter slat 20.

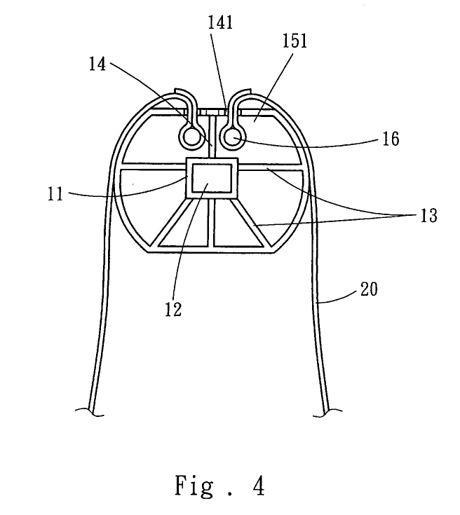

By means of the construction set forth above, for assembly, couple the threading hole 21 of the shutter slat 20 on the bracing rod 16 of the fastening device 10, and flip the shutter slat 20 over the outer surface of the fastening device 10 to be draped in a pendant manner (as shown in FIG. 4). As the slot 17 has an undulate slip-resistant section 171 on the outer edge, it prevents the threading hole 21 of the shutter slat 20 from sliding off the bracing rod 16. In addition, the narrow clamping section 172 in the slot 17 can clamp the inner side of the threading hole 21 of the shutter slat 20, the shutter slat 20 may be fastened rapidly and securely on the upper side of the fastening device 10.

1. A shutter slat fastening device for fastening a pendant shutter slat which has a threading hole on an upper side thereof, the fastening device comprising:
a substantially hollow barrel having a transverse beam extended in the axial direction, the beam having a hole in the center to house a rod mounted on a window, the transverse beam having a vertical plate on an upper side to form two housing troughs with the peripheral wall of the fastening device, the housing troughs having one closed end and another open end, and a bracing rod extended from the closed end to couple with the threading hole of the shutter slat, the fastening device further having a top side with two slots above the housing troughs, the slots having respectively one undulate edge to form a slip-resistant section to clamp the shutter slat.

2. The shutter slat fastening device of claim 1, wherein the vertical plate has a top side extending respectively forwards and rearwards to form a clamping edge on an inner edge of the slot which has an outer edge forming the undulate slip-resistant section, the top side of the fastening device being horizontal.

3. The shutter slat fastening device of claim 1, wherein the slot forms a narrow clamping section abutting the closed end.

4. The shutter slat fastening device of claim 1, wherein the slip-resistant section is located on an outer edge of the slot.

5. The shutter slat fastening device of claim 1, wherein the slot has an open end formed in a horn shape.

6. The shutter slat fastening device of claim 1, wherein the transverse beam is connected to the peripheral wall of the fastening device through a plurality of ribs.

7. The shutter slat fastening device of claim 1, wherein the transverse beam has respectively, a left and a right horizontal rib to form a spacer, the bracing rod being located above the spacer at a selected distance.

8. The shutter slat fastening device of claim 1, wherein the hole in the center of the transverse beam is polygonal with a shape corresponding to and coupling with the rod mounted on the window.
